(19) United States
(12) Patent Application Publication
(10) Pub. No.: US 2017/0084136 A1
(43) Pub. Date: Mar. 23, 2017

(54) Methods and Systems to Improve the Visibility of Electrical and Electronic Devices, Connectors and Accessories

(71) Applicant: Iman Rezanezhad Gatabi, San Jose, CA (US)

(72) Inventor: Iman Rezanezhad Gatabi, San Jose, CA (US)

(21) Appl. No.: 15/338,416

(22) Filed: Oct. 30, 2016

Related U.S. Application Data
(62) Division of application No. 14/941,659, filed on Nov. 15, 2015.
(60) Provisional application No. 62/086,221, filed on Dec. 2, 2014.

(51) Int. Cl. G08B 5/36; F21S 9/02

(52) U.S. Cl. CPC G08B 5/36; F21S 9/02; F21Y 2115/10

(57) ABSTRACT

This application discloses a method to implement a light source in a cable, or in an electrical or electric connector, or in an electrical or electric adapter, or in a charger, or in an electrical or electronic plug. Said method comprises of implementation of a rechargeable electrical or electronic power source that may provide a power to turn ON the said light source. The said power source may charge up when the said cable, or connector, or adapter, or charger or plug is electrically or electronically connected to another electrical or electronic device, or to another cable, or to another connector, or to another adapter, or to another plug or to a mains power. Circuits and devices to implement the said method are also disclosed.

### CROSS-REFERENCE TO RELATED APPLICATIONS

This application is a divisional application of U.S. non-provisional application Ser. No. 14/941,659, filed on Nov. 11, 2015 which claims the benefits of U.S. provisional application Ser. No. 62/086,221, filed on Dec. 2, 2014.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Visibility of electrical and electronic devices is important in the dark environments. Many of recent power outlets, electrical switches mounted on walls and buttons of computers have Light Emitting Diodes (LEDs) that makes them visible in dark rooms or during the night. However, devices like cell phone chargers, electrical plugs of home appliances, flash memory sticks or some electrical connectors like USB connectors lack light sources that are ON (at least for a fraction of time) when the said devices are not connected to an external electrical or electronic power source. Implementation of light sources like LEDs in the said devices is important to make them visible in the dark environments when they are not connected to a power outlet or other connector (s).

### BRIEF SUMMARY OF THE INVENTION

This invention describes a method to implement a light source in a cable, or in an electrical or electric connector, or in an electrical or electric adapter, or in a charger, or in an electrical or electronic plug. Said method comprises of implementation of a rechargeable electrical or electronic power source, wherein the said power source may provide a power to turn ON the said light source, wherein the said power source may charge up when the said cable, or connector, or adapter, or charger or plug is electrically or electronically connected to another electrical or electronic device, or to another cable, or to another connector, or to another adapter, or to another plug or to a mains power. Circuits and devices to implement the said method are also discussed.

### BRIEF DESCRIPTION OF THE SEVERAL VIEWS OF THE DRAWING

FIG. 1 shows a prior art where it depicts an electric power plug mounted on a wall.

FIG. 2 shows a prior art where it depicts an electric wall switch in order to turn ON or OFF a lamp.

FIG. 3 shows an example embodiment of implementation of the invention where it depicts a smartphone charger with a light source.

FIG. 4 shows an example embodiment of implementation of the invention where it depicts a flash memory stick with an LED.

FIG. 5 shows an example embodiment of implementation of the invention where it depicts a TV set wherein the plug of its power cord has an LED.

FIG. 6 shows an example embodiment of implementation of the invention where it depicts a smartphone to USB adapter wherein a first LED is implemented in the USB connector in one end of the cable of the said adapter and a second LED is implemented in the smartphone connector in the other end of the said cable.

FIG. 7 shows an electronic circuit that can be used to implement the invention.

### DETAILED DESCRIPTION OF THE INVENTION

Different examples will be described in details that represent some example embodiments of the present invention. However the technical and structural descriptions presented herein are representative for the purposes of describing the present invention, the described invention may be embodied in many alternate forms and should not be limited to the example embodiments described herein.

The described examples can be modified in various alternative forms. For example, the thickness and dimensions of the regions in drawings may be exaggerated for clarity. There is no intention to limit the invention to the particular forms disclosed herein. However, examples are used to describe the present invention and to cover some modifications and alternatives within the scopes of the invention.

The spatially relative terms used here such as “underneath”, “below” and “above” are for the ease of description and to show the relationship between an element and another one in the figures. If the device in the figure is turned over, elements described as “underneath” or “below” other elements would then be “above” other elements. Therefore, for example, the term “underneath” can represent an orientation which is below as well as above. If the device is rotated, the spatially relative terms used herein should be interpreted accordingly.

Unless otherwise stated, variations of the shapes of the figures as a result of, for example, manufacturing techniques and tolerances are expected. Therefore, the regions illustrated in figures are schematic and their shapes do not necessarily show the actual shape of the fabricated device. Unless otherwise stated, there is no intention to limit the invention to the values (such as dimensions and voltages) that may be used to describe the example embodiments. These values are selected to describe the related characteristics for a better understanding of the presented methods or devices. Unless otherwise stated, the terms used herein have the same meaning as commonly understood by someone with ordinary skills in the invention field.

Throughout this document, the whole device structure or the entire systems in provided example embodiments may not be presented for the sake of simplicity. This can be understood by someone with ordinary expertise in the field of invention. For example, when showing a TV set, we may just show the screen and turn ON/OFF button and not the volume buttons. In such cases, any new or well-known designs for the un-shown parts are expected. Therefore, it should be understood that the provided example embodiments may just have illustrations that are mainly intended to show the scope of the invention and different designs of other parts of the presented example embodiments are expected.

This invention describes a method to implement a light source in a cable, or in an electrical or electric connector, or in an electrical or electric adapter, or in a charger, or in an electrical or electronic plug, said method comprises of implementation of a rechargeable electrical or electronic power source, wherein the said power source may provide a power to turn ON the said light source, wherein the said power source may charge up when the said cable, or connector, or adapter, or charger or plug is electrically or electronically connected to another electrical or electronic device, or to another cable, or to another connector, or to another adapter, or to another plug or to a mains power.

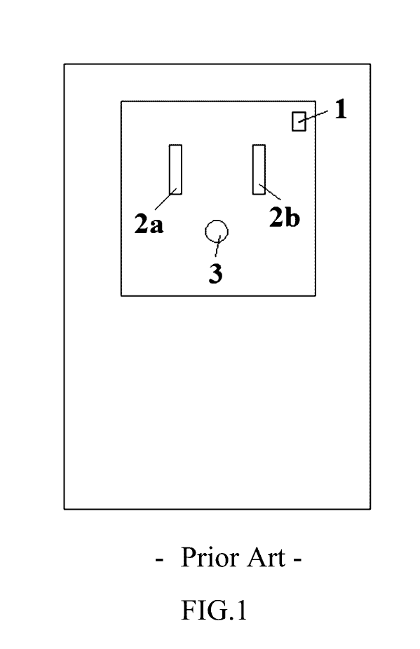

FIG. 1 shows a prior art related to the present invention where it depicts an electric power plug mounted on a wall. Said power plug has a Light Emitting Diode (LED) 1, which is ON when there is not an electrical power outage. 2a and 2b are connectors to the mains electricity and 3 is a connector to earth ground. In this prior art, LED 1 may make the said power plug more visible in dark environments. However, LED 1 will turn OFF when there is an electrical power outage.

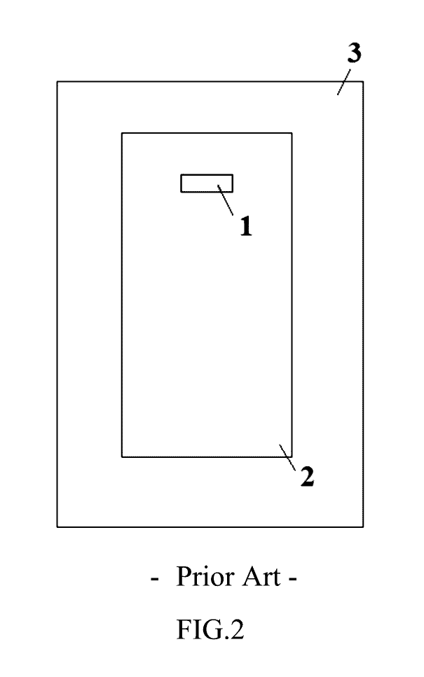

FIG. 2 shows a prior art related to the present invention where it depicts an electric wall switch in order to turn ON or OFF a lamp. Said switch has a Light Emitting Diode (LED) 1, which is ON when there is not an electrical power outage. 2 is a button to turn ON or OFF the said lamp and 3 is the frame of the said electric wall switch. In this prior art, LED 1 may make the said switch more visible in dark environments. However, LED 1 will turn OFF when there is an electrical power outage.

Another prior art in this field is a power button on the case of a Personal Computer (PC) used to turn ON or OFF the said PC, wherein the said button has an LED, wherein the said LED is ON when the power cord of the said PC is hooked up to an electric power plug and when there is not an electric power outage. In this prior art, said LED may make the said button more visible in dark environments. However, said LED will turn OFF when the said PC is not connected to an electric power plug or when there is an electric power outage.

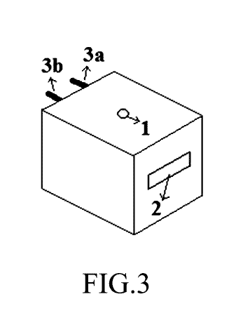

FIG. 3 shows an example embodiment of implementation of the present invention where it depicts a smartphone charger comprising of a light source 1, said charger has a rechargeable battery (not shown in this picture), wherein the said battery provides a power to turn ON the said light source 1, wherein the said battery may charge up when the said charger is electrically connected to an electrical power outlet of a wall. Here, 2 is a USB connector and 3a and 3b are connectors to connect the said charger to an electrical power outlet of a wall. In this example embodiment, the light source 1 is ON even when the said charger is not plugged to an electrical power outlet of a wall until the said battery runs out of charge. In other example embodiments, when the said charger is not electrically connected to an electrical power plug of a wall, the light source 1 may flash instead of being constantly ON. In other example embodiments, a capacitor or a super capacitor may be implemented instead of the said battery.

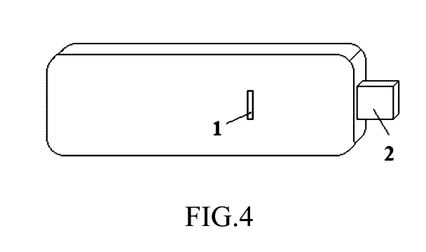

FIG. 4 shows an example embodiment of implementation of the present invention where it depicts a flash memory stick comprising of an LED 1, said flash memory stick has a rechargeable battery (not shown in this picture), wherein the said battery provides a power to turn ON the said LED 1, wherein the said battery may charge up when the said flash memory stick is electronically connected to a USB connector of a computer. Here, 2 is a USB connector. In this example embodiment, the LED 1 is ON even when the said flash memory stick is not plugged to a USB connector of a computer until the said battery runs out of charge. In other example embodiments, when the said flash memory stick is not electronically connected to a USB connector of a computer, the LED 1 may flash instead of being constantly ON. In other example embodiments, a capacitor or a super capacitor may be implemented instead of the said battery.

It should be mentioned that the said light source as described in the present invention may be of any type including (but not limited to), LEDs and lamps and it may have any shape or dimensions.

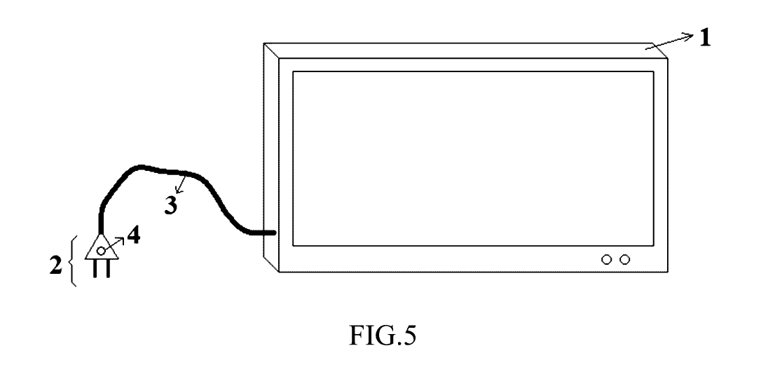

FIG. 5 shows another example embodiment of implementation of the present invention where it depicts a TV set 1 wherein the plug 2 of its power cord 3 has an LED 4. A rechargeable battery (not shown in this picture) is implemented in the TV set 1 (or inside the plug 2 in other example embodiments), wherein the said battery provides a power to turn ON the said LED 4, wherein the said battery may charge up when the said plug 2 is connected to an electrical power outlet of a wall. In this example embodiment, the LED 4 is ON even when the said plug is not connected to an electrical power outlet of a wall until the said battery runs out of charge. In other example embodiments, when the said plug is not connected to an electrical power outlet of a wall, the LED 4 may flash instead of being constantly ON. In other example embodiments, a capacitor or a super capacitor may be implemented instead of the said battery.

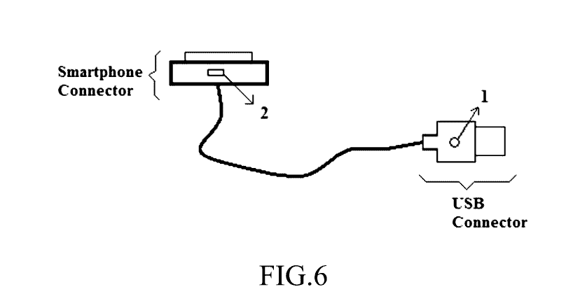

FIG. 6 shows another example embodiment of implementation of the present invention where it depicts a smartphone to USB adapter wherein a first LED 1 is implemented in the USB connector in one end of the cable of the said adapter and a second LED 2 is implemented in the smartphone connector in the other end of the said cable. Said adapter comprises of a rechargeable battery (not shown in this picture which may be implemented anywhere in the said cable or in the said connectors), wherein the said battery provides a power to turn ON the said LEDs (1 and 2), wherein the said battery may charge up when the said adapter is electronically connected to a smartphone or when the said adapter is electronically connected to a USB connector of a computer or charger. In this example embodiment, the said LEDs (1 and 2) are ON even when the said adapter is not plugged to a USB connector of a computer or charger or even when it is not plugged to a smartphone, until the said battery runs out of charge.

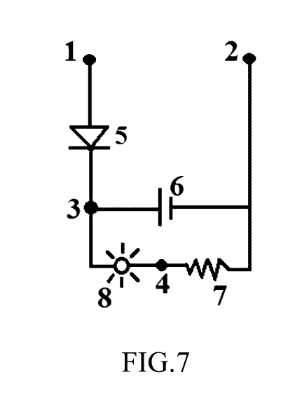

FIG. 7 shows an electronic circuit that can be used to implement the present invention, said circuit has a first 1 and a second 2 and a third 3 and a fourth 4 electrical node, wherein the said first node is electrically connected to an anode of a diode 5, wherein the said second node 2 is electrically connected to a first electrical terminal of a rechargeable power source 6 and a first electrical terminal of a resistor 7, wherein the said third node is electrically connected a cathode of the said diode 5 and to a second electrical terminal of the said power source 6 and to a first electrical terminal of a light source 8, wherein the said fourth node is electrically connected to a second electrical terminal of the said light source 8 and to a second electrical terminal of the said resistor 7, wherein the said first and second nodes (1 and 2) can be electrically connected to the wires of a cable, or to electrical terminals of an electrical or electric connector, or to electrical terminals of an electrical or electric adapter, or to electrical terminals of a charger, or to electrical terminals of an electrical or electronic plug.

1. A method to implement a light source in a cable, or in an electrical or electric connector, or in an electrical or electric adapter, or in a charger, or in an electrical or electronic plug, said method comprises of implementation of a rechargeable electrical or electronic power source, wherein the said power source may provide a power to turn ON the said light source, wherein the said power source may charge up when the said cable, or connector, or adapter, or charger or plug is electrically or electronically connected to another electrical or electronic device, or to another cable, or to another connector, or to another adapter, or to another plug or to a mains power.

2. The method of claim 1, wherein the said charger is a smartphone charger or a tablet charger.

3. The method of claim 1, wherein the said light source is a Light Emitting Diode.

4. The method of claim 1, wherein the said rechargeable electrical or electronic power source is a capacitor, or a super capacitor or a rechargeable battery.

5. An electronic circuit used to implement the method of claim 1, said circuit has a first and a second and a third and a fourth electrical node, wherein the said first node is electrically connected to an anode of a diode, wherein the said second node is electrically connected to a first electrical terminal of the said power source and a first electrical terminal of a resistor, wherein the said third node is electrically connected a cathode of the said diode and to a second electrical terminal of the said power source and to a first electrical terminal of the said light source, wherein the said fourth node is electrically connected to a second electrical terminal of the said light source and to a second electrical terminal of the said resistor, wherein the said first and second nodes are electrically connected to the wires of the said cable, or to electrical terminals of the said electrical or electric connector, or to electrical terminals of the said electrical or electric adapter, or to electrical terminals of the said charger, or to electrical terminals of the said electrical or electronic plug.

6. The method of claim 1, wherein the said light source may flashes.
